(19) United States
(12) Patent Application Publication
(10) Pub. No.: US 2024/0124243 A1
(43) Pub. Date: Apr. 18, 2024

(54) Slat for a reciprocating slat conveyor

(71) Applicant: Cargo Mac B.V., Coevorden (NL)

(72) Inventors: Frans Arian Heino DE RAAD, COEVORDEN (NL); Nicolaas Marc MATER, COEVORDEN (NL)

(21) Appl. No.: 18/277,051

(22) PCT Filed: Feb. 15, 2022
(86) PCT No.: PCT/NL2022/050076

§ 371 Date: Aug. 11, 2023

Related U.S. Application Data
(60) Provisional application No. 63/151,442, filed on Feb. 19, 2021.

(30) Foreign Application Priority Data
Feb. 19, 2021 (NL) 2027595

(51) Int. Cl. B65G 25/06; B65G 67/20

(52) U.S. Cl. CPC B65G 25/065; B65G 67/20

(57) ABSTRACT

The invention relates to a slat for a reciprocating slat conveyor, where the slat comprises an elongated slat body having an upper surface configured for supporting a load placed on the slat, a bottom surface, opposite to the upper surface, a first side surface and a second side surface, opposite to the first side surface, wherein at least one of the upper surface, bottom surface, first side surface and second side surface is at least partially provided with a wear member.

### BACKGROUND

The invention relates to a slat for a reciprocating slat conveyor.

Furthermore, the invention relates to a reciprocating slat conveyor provided with multiple slats.

A reciprocating floor conveyor is known from the U.S. patent publication U.S. Pat. No. 4,143,760. The known slat conveyor comprises at least one group of at least two elongated slats mounted side-by-side on a frame for longitudinal reciprocation to form the reciprocating slat conveyor, the slats being connected to a fluid pressure drive mechanism which is operable to move all of the slats of each group from a start position simultaneously in a load-conveying direction and then to move the slats of each group sequentially in the opposite direction from the advanced position back to the start position, the slats of each group being interengaged to insure simultaneous movement.

### SUMMARY OF THE INVENTION

During use of the reciprocating floor conveyor, the elongated slats are moved reciprocally in the load-conveying direction. During the movement in the direction opposite to the load-conveying direction, adjacent slats are moved with respect to each other. The inventors have found that the durability of the known reciprocating floor conveyor is no longer in line with the current vision of sustainability.

It is an object of the present invention ameliorate or to eliminate one or more disadvantages of the known reciprocating floor conveyor, to provide an improved reciprocating floor conveyor or to at least provide a reciprocating floor conveyor.

According to a first aspect, the invention provides a slat for a reciprocating slat conveyor, the slat comprising:
an elongated slat body having an upper surface configured for supporting a load placed on the slat, a bottom surface, opposite to the upper surface, a first side surface and a second side surface, opposite to the first side surface,
wherein the slat is at least at one of the upper surface, bottom surface, first side surface and second side surface of the elongated slat body at least partially provided with a wear member.

During use of the slat according to the invention, the slat is installed in a reciprocating floor conveyor, for example, mounted within a trailer. During use adjacent slats move with respect to each other in order to move a load in the load-conveying direction of the reciprocating floor conveyor. Movement of adjacent slats with respect to each other may result in wear of the elongated slat bodies of the adjacent slats. By providing a wear member at the side surfaces of the elongated slat bodies, i.e. surfaces of the elongated slat bodies facing towards the adjacent slat, movement of the slats with respect to each other results in wear of the wear members, instead of the elongated slat bodies. This is advantageous, as the expected lifespan of the slat according to the invention, therewith, is increased in comparison with the expected lifespan of the known slat. The slat according to the invention, therefore, is more or completely in line with the current vision of sustainability.

In an embodiment, at least a part of one or each of the first side surface and the second side surface is provided with a wear member.

In an embodiment, at least a part of the bottom surface is provided with a wear member.

In an embodiment, at least a part of the upper surface is provided with a wear member.

In an embodiment, the elongated slat body comprises a top wall, and a left and right side wall arranged at a longitudinal side of the top wall and extending downwards therefrom. In an embodiment thereof, each of the left and right side walls comprises a first wall part connected to the top wall and extending substantially perpendicular thereto, and a second wall part arranged at the end of the first wall part facing away from the top wall and extending towards the second wall part of the other one of the left and right side walls.

In an embodiment, the wear member is arranged at the first wall part of one of the left and right side walls, and a further wear member is arranged at the first wall part of the other of the left and right side walls. According to this embodiment, the first and second side surfaces of the elongated slat body are covered by a wear member. This is advantageous, as contact between adjacent slats results advantageously in wear to the wear member and the further wear member, instead of the elongated slat body.

In an embodiment, the first wall part of the left and right side walls has a height, and the wear member and the further wear member extend over substantially the complete height of the respective first wall part.

In an alternative embodiment thereof, the first wall part of the left and right side walls has a height, and the wear member extends over substantially the complete height of the respective first wall part and the further wear member extends over a part of the height of the respective first wall part. According to this embodiment, it is possible to apply, for example, a seal between two adjacent slats, which seal is arranged at the part of the respective first wall part free from the wear member or the further wear member.

In an embodiment, the wear member and the further wear member are also arranged at the second wall part of the respective side wall. An advantage of this embodiment is that contact between a support structure of a reciprocating floor conveyor along which the slat moves during use, results in wear of the wear member and the further wear member instead of the elongated slat body.

In an embodiment, the wear member comprises a U-shaped wear body having a bottom portion and two legs standing upright from the bottom portion, wherein the bottom portion is arranged at the second wall parts of the left and right side walls and the two legs are arranged at at least a part of the first wall parts of the left and right side walls.

In an embodiment, the wear member comprises an inverted U-shaped wear body having a bottom portion and two legs standing upright from the bottom portion, wherein the bottom portion is arranged at the top wall and the two legs are arranged at at least a part of the first wall parts of the left and right side walls.

In an embodiment, the wear member is a wear strip or wear profile. In an embodiment thereof, the wear member is a L-shaped wear strip or L-shaped wear profile.

In an embodiment, the wear member is substantially beam-shaped, such that the slat is located within the wear member. By providing the slat within the wear member, each side of the slat is covered by the wear member. As a result, the slat is prevented from experiencing wear all around.

In an embodiment, the wear member is arranged removably at at least one of the upper surface, bottom surface, first side surface and second side surface. An advantage of this embodiment is that the wear member may be replaced when it is determined that the wear of the wear member has exceeded a predetermined level. Therewith, the lifespan of the slat may be increased even more.

In an embodiment, the wear member is manufactured from a material selected from the group comprising steel, wear aluminum, aluminum, plastics or the like. Wear aluminum has to be understood as aluminum that is harder than the aluminum of which the elongated slat body may be made.

In an embodiment, the wear member is arranged at the elongated slat body by means of welding, gluing, riveting, screwing, clamping or the like.

In an embodiment, the slat is provided with an end cap mounted at one or both of the outer ends of the slat. Preferably the end cap is connected to the wear member or to the elongated slat body solely.

According to a second aspect, the invention provides a reciprocating slat conveyor comprising a support structure or subdeck, multiple parallel elongate slats according to the first aspect of the invention, that are supported by the support structure and that are slidable in the longitudinal direction with respect to the support structure, slide bearings between the support structure and the slats, and a drive mechanism for reciprocating sliding movement of the slats with respect to the support structure.

The reciprocating slat conveyor has at least the same technical advantages as described in relation to the slat according to the first aspect of the invention.

According to a third aspect, the invention provides a trailer or truck comprising a reciprocating slat conveyor according to the second aspect of the invention.

The various aspects and features described and shown in the specification can be applied, individually, wherever possible. These individual aspects, in particular the aspects and features described in the attached dependent claims, can be made subject of divisional patent applications.

### BRIEF DESCRIPTION OF THE DRAWINGS

The invention will be elucidated on the basis of an exemplary embodiment shown in the attached drawings, in which:

FIG. 1 shows a trailer with a reciprocating slat conveyor with multiple slats according to a first embodiment of the invention;

FIG. 2 shows a part of the reciprocating slat conveyor of FIG. 1, wherein some of its slats have been cut and partially removed to show its underlying slide bearings;

FIG. 3 shows a cross-section of one of the slats of the reciprocating slat conveyor of FIG. 1 according to a first embodiment of the invention;

FIG. 4 shows a cross-section of one of the slats of the reciprocating slat conveyor of FIG. 1 according to another embodiment of the invention;

FIG. 5 shows a cross-section of one of the slats of the reciprocating slat conveyor of FIG. 1 according to another embodiment of the invention;

FIG. 6 shows a cross-section of one of the slats of the reciprocating slat conveyor of FIG. 1 according to another embodiment of the invention;

FIG. 7 shows a cross-section of one of the slats of the reciprocating slat conveyor of FIG. 1 according to another embodiment of the invention;

FIG. 8 shows an alternative embodiment of the slat of FIG. 3;

FIG. 9 shows an alternative embodiment of the slat of FIG. 4;

FIG. 10 shows an alternative embodiment of the slat of FIG. 5; and

FIG. 11 shows a bottom view of one of the slats of FIG. 5, 7 or 10 according to an embodiment of the invention.

### DETAILED DESCRIPTION OF THE INVENTION

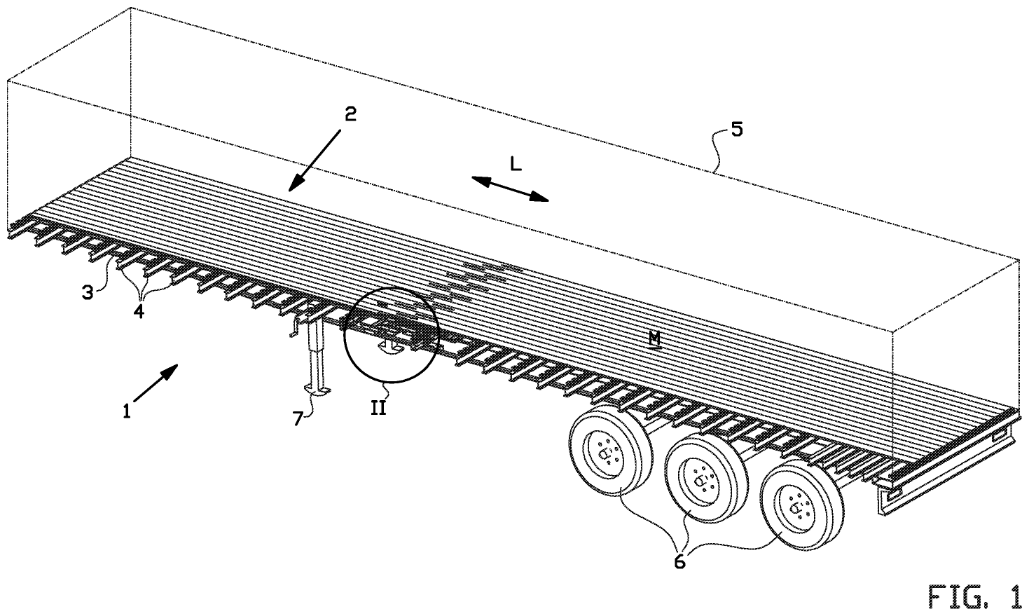

FIG. 1 shows a trailer 1 with a reciprocating slat conveyor 2 according to an embodiment of the invention. The trailer 1 comprises two longitudinal frame bars 3 and multiple transverse frame bars 4 mounted thereon, and a schematically indicated hood 5 that covers the area above the reciprocating slat conveyor 2. The trailer 1 furthermore comprises multiple wheel axes 6, and two retractable stands 7 to support the uncoupled trailer 1. The reciprocating slat conveyor 2 according to the invention is not limited to trailer applications, but can also be applied in trucks or in fixed structures. The reciprocating slat conveyor 2 has a horizontally extending main plane M that extends over the entire cargo area of the trailer 1 or the reciprocating slat conveyor 2. The reciprocating slat conveyor 2 is configured to move the cargo forwards and backwards in the main plane M in its longitudinal direction L as described hereafter.

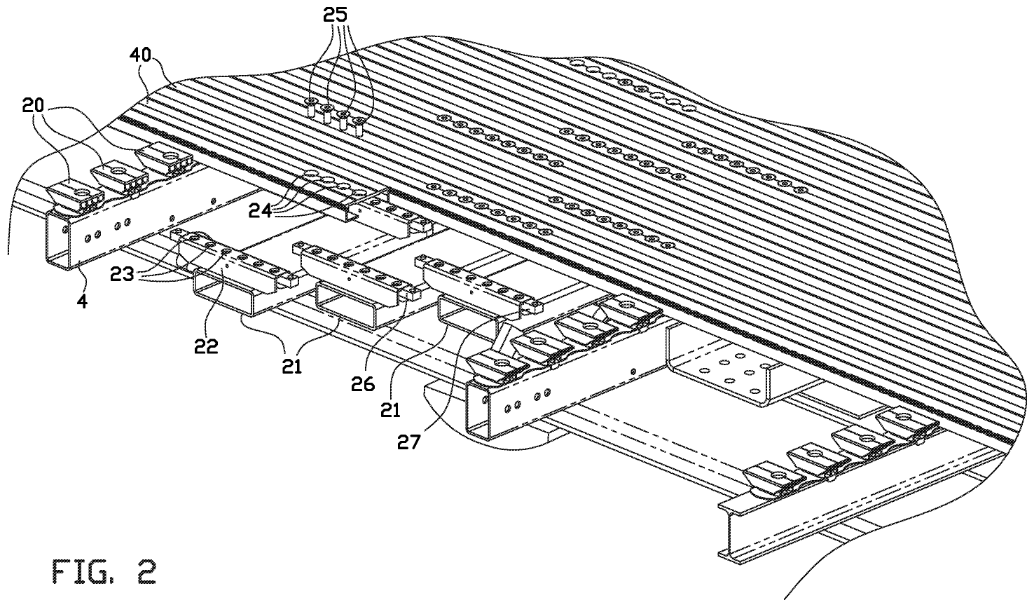

The reciprocating slat conveyor 2 is shown in more detail in FIG. 2. The reciprocating slat conveyor 2 comprises multiple first slide bearings 20 that are mounted to the transverse frame bars 4 and multiple first slats 40 that are supported by the first slide bearings 20. The transverse frame bars 4 form a support structure of the reciprocating slat conveyor 2. The first slats 40 extend parallel to each other in the main plane M and in the longitudinal direction L of the reciprocating slat conveyor 2. The first slide bearings 20 may alternatively be supported by a subdeck that forms a supporting layer between the first slide bearings 20 and the longitudinal frame bars 3 or the transverse frame bars 4. The reciprocating slat conveyor 2 according to the invention is suitable to operate as heavy duty conveyor or high impact conveyor to handle hard or abrasive bulk goods such as steel scrap, or palletized heavy cargo.

The first slats 40 of the reciprocating slat conveyor 2 repetitively form part of a first group, a second group or a third group of first slats 40 and are per group connected to a dedicated drive beam 21 that extends transversely below the first slats 40. The drive beams 21 form part of an hydraulic drive mechanism that is known per se and therefore not shown in the drawings. This hydraulic drive mechanism is configured to shift one of the groups of first slats 40 in the longitudinal direction L with respect to the remaining groups of first slats 40 in subsequent cycles whereby cargo on the first slats 40 slides only in one loading direction or unloading direction.

For the connection between the first slat 40 and its drive beam 21 the hydraulic drive mechanism is provided with multiple connectors 22 having mounting holes 23 that are welded onto the drive beams 21. Each first slat 40 is provided with a series of mounting holes 24 that correspond with the mounting holes 23 of the connectors 22 to receive series of bolts 25. The bolts 25 are fixated by means of steel strips 26 that are inserted in the connectors 22 and that are provided with threaded holes 27 for the bolts 25.

A cross-sectional view of one of the slats 40 of FIG. 1 or FIG. 2 according to a first embodiment of the invention is shown in FIG. 3. The slat 40 comprises an elongated slat body 41 having an upper surface 39 configured for supporting a load placed onto the slat 40, and a bottom surface 42, opposite to upper surface 39, configured for supporting the slat 40 with respect to the transverse frame bars 4 there below. The elongated slat body 41 further includes a first side surface 43 configured for facing towards a neighbouring slat 40, and a second side surface 44, opposite to the first side surface 43, configured for facing towards another neighbouring slat 40.

As shown in FIG. 3, the elongated slat body 41 comprises a top wall 45 defining the upper surface 39 of the slat 40, and a left and right side wall 46, 47 arranged at a longitudinal side of the top wall 45 and extending downwards therefrom. Each of the left and right side walls 46, 47 comprises a first wall part 48 connected to the top wall 45 and extending substantially perpendicular thereto, and a second wall part 49 arranged at the end of the first wall part 48 that faces away from the top wall 45 and extending substantially parallel thereto. The top wall 45 is provided with two ridges 50 at the upper surface thereof, which two ridges 50 extend substantially in the longitudinal direction of the elongated slat body 41. At the side of the left side wall 46, the top wall 45 is provided with a projecting nose or edge 51 configured for facing the top wall 45 of the adjacent slat 40.

The left wall 46 is further provided with a locking chamber 52 inside the left side wall 46. The locking chamber 52 has a passage section 53 bounded by two opposite locking edges 54, and a wide confinement section 55. The locking chamber 52 is shown empty for illustrative purposes only, and is configured for receiving a non-shown seal. Although not shown, the right wall 47 may be provided with a locking chamber 52 too, in addition to or instead of the locking chamber 52 in the left wall 46.

As shown in FIG. 3, the slat 40 further is provided with a first wear member 60 and a second wear member 61. The first wear member 60 is provided at the right side wall 47 of the elongated slat body 41, and has an elongated strip-like first wear body 63 extending along the longitudinal direction of the right side wall 47. The elongated strip-like first wear body 63 may extend over substantially the whole length or over a part of the elongated slat body 41, or may be provided intermittently. Furthermore, the height of the elongated strip-like first wear body 63 is substantially the same as the height of the first wall part 48.

The second wear member 61 is arranged at the left side wall 46 of the elongated slat body 41, and has an elongated strip-like second wear-body 65 extending along the longitudinal direction of the left side wall 46. The elongated second strip-like wear body 65 may extend over substantially the whole length or over a part of the elongated slat body 41, or may be provided intermittently. As shown in FIG. 3, the elongated strip-like second wear body 65 has a skewed upper end 66, such that the elongated strip-like second wear body 65 may be placed against the projecting nose or edge 51. This is applicable mutatis mutandis to all embodiments described hereafter.

The elongated slat body 41, for example, may be manufactured from aluminum, and each of the first and second wear members 60, 61 may be manufactured from a material selected from the group comprising steel, wear aluminum that is more wear resistant than the aluminum of the elongated slat body 41, aluminum, plastics, or the like. The first and second wear members 60, 61 may be secured to the elongated slat body 41, for example, by means of welding, gluing, riveting, screwing, clamping or the like. Optionally, the first and second wear members 60, 61 are secured to the elongated slat body in a removable manner, such that the first and second wear members 60, 61 are the wear parts of the slat 40 that may be replaced when necessary. This is applicable mutatis mutandis to all embodiments described hereafter.

Optionally, the slat 40 is provided with a non-shown end cap mounted at one or both of the outer ends thereof. The non-shown end cap may be connected to the first wear member 60 and/or the second wear member 61, or to the elongated slat body 41 solely.

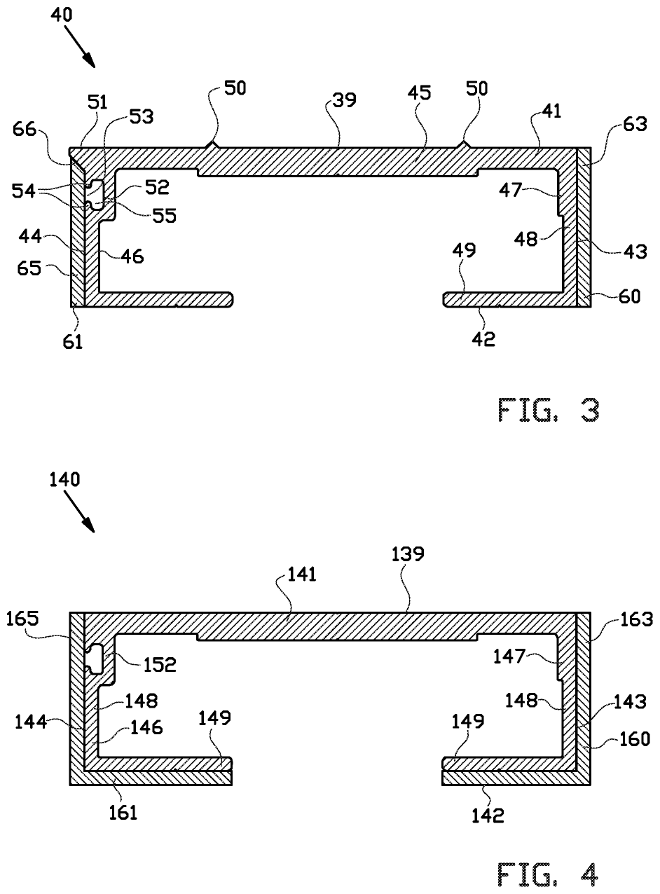

A cross-sectional view of one of the slats 40 of FIG. 1 or FIG. 2 according to another embodiment of the invention is shown in FIG. 4. In order to refrain from reintroducing components of the slat, similar components are referred to by the same reference number increased with 100 with respect to the description of the slat 40 shown in FIG. 3.

This embodiment of the slat 140 differs from the slat 40 of FIG. 3 in that the wear body 163, 165 of the first and second wear members 160, 161 according to this embodiment are L-shaped strip-like wear bodies 163, 165. The first wear member 160 is arranged at the right side wall 147, such that it covers the first and second wall part 148, 149 of the right side wall 147. The second wear member 161 is arranged at the left side wall 146, such that it covers the first and second wall part 148, 149 of the left side wall 146.

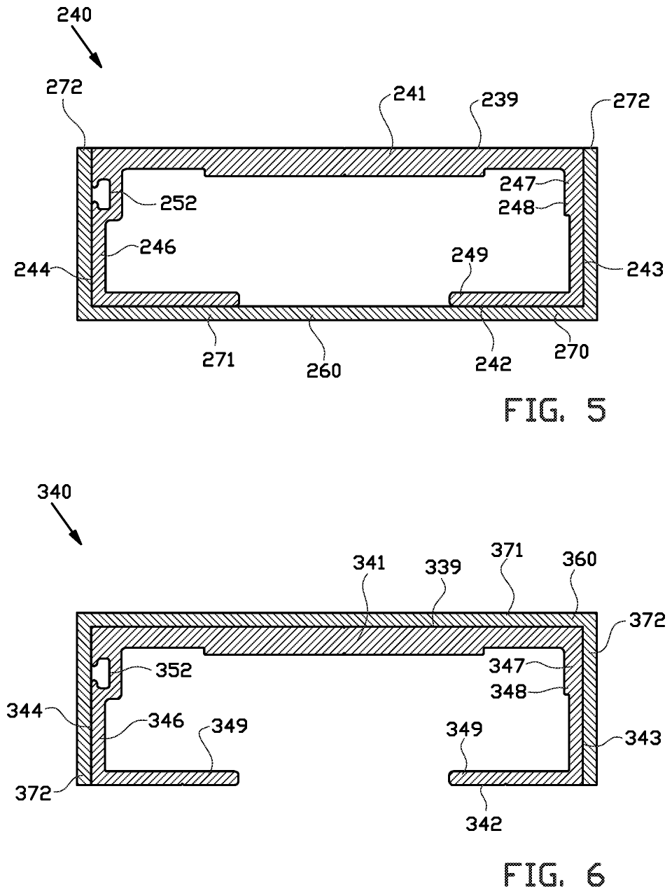

A cross-sectional view of one of the slats 40 of FIG. 1 or FIG. 2 according to another embodiment of the invention is shown in FIG. 5. In order to refrain from reintroducing components of the slat, similar components are referred to by the same reference number increased with 200 with respect to the description of the slat 40 shown in FIG. 3.

This embodiment of the slat 240 differs from the slat 40 of FIG. 3 in that the slat 240 is provided with a single wear member 260. The wear member 260 comprises a U-shaped wear body 270 having a bottom portion 271 and two legs 272 standing upright from the bottom portion 271. As shown in FIG. 5, the two legs 272 cover the first wall parts 248 of the left and right side walls 246, 247 completely, and the bottom portion 271 covers the bottom surface 242 completely.

A cross-sectional view of one of the slats 40 of FIG. 1 or FIG. 2 according to another embodiment of the invention is shown in FIG. 6. In order to refrain from reintroducing components of the slat, similar components are referred to by the same reference number increased with 100 with respect to the description of the slat 240 shown in FIG. 5.

This embodiment of the slat 340 differs from the slat 240 of FIG. 5 in that the single wear member 360 comprises an inverted U-shaped wear body 370 having a base portion 371 and two legs 372 extending downwards from the base portion 371. As shown in FIG. 6, the two legs 372 cover the first wall parts 348 of the left and right side walls 346, 247 completely, and the base portion 371 covers the upper surface 339 completely.

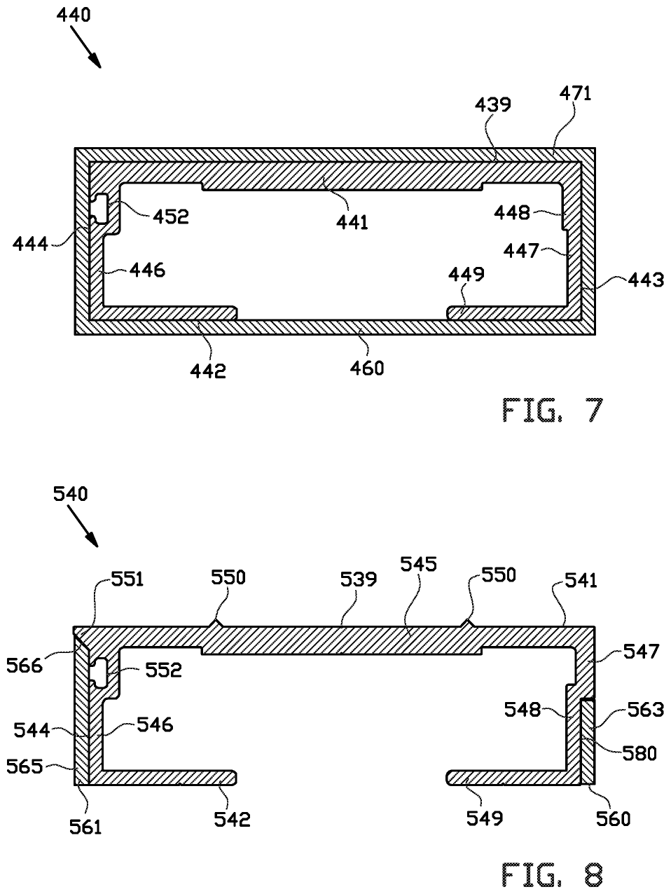

A cross-sectional view of one of the slats 40 of FIG. 1 or FIG. 2 according to another embodiment of the invention is shown in FIG. 7. In order to refrain from reintroducing components of the slat, similar components are referred to by the same reference number increased with 400 with respect to the description of the slat 40 shown in FIG. 3.

This embodiment of the slat 440 differs from the slat 40 of FIG. 3 in that the slat 440 is provided with a single wear member 460 having a hollow beam-shaped wear body 471. Because of the hollow beam-shaped wear body 471, the elongated slat body 441 is, so to speak, arranged within the hollow beam-shaped wear body 471, such that the upper surface 439, the bottom surface 442, the first side surface 443 and the second side surface 444 are covered by the wear member 460.

A cross-sectional view of the slat 40 of FIG. 3 according to an alternative embodiment is shown in FIG. 8. In order to refrain from reintroducing components of the slat, similar components are referred to by the same reference number increased with 500 with respect to the description of the slat 40 shown in FIG. 3.

This embodiment of the slat 540 differs from the slat 40 of FIG. 3 in that the right side wall 547, in particular the first wall part 548 thereof, is provided with a recess 580 provided at the outer surface thereof, which recess 580 extends upwards from the bottom edge of the right side wall 547 to substantially halfway the total height of the first wall part 548. The first wear member 560 is arranged within the recess 580 of the right side wall 547, such that the outer surface of the elongated strip-like wear body 563 is substantially flush with the outer surface of the first wall part 548.

A cross-sectional view of the slat 140 of FIG. 4 according to an alternative embodiment is shown in FIG. 9. In order to refrain from reintroducing components of the slat, similar components are referred to by the same reference number increased with 500 with respect to the description of the slat 140 shown in FIG. 4.

This embodiment of the slat 640 differs from the slat 140 of FIG. 4 in that the right side wall 647, in particular the first wall part 648 thereof, is provided with a recess 680 provided at the outer surface thereof, which recess 680 extends upwards from the bottom edge of the right side wall 647 to substantially halfway the total height of the first wall part 648. The first wear member 660, which is substantially L-shaped, is partially arranged within the recess 680 of the right side wall 647, such that the outer surface of the part of the elongated strip-like wear body 563 within the recess 680 is substantially flush with the outer surface of the first wall part 648.

Furthermore, the top wall 645 is provided with a projecting nose or edge 651 at the side of the left side wall 646. The elongated L-shaped strip-like wear body 665 has a skewed upper end 666, such that the elongated strip-like wear body 665 may be placed against the projecting nose or edge 651.

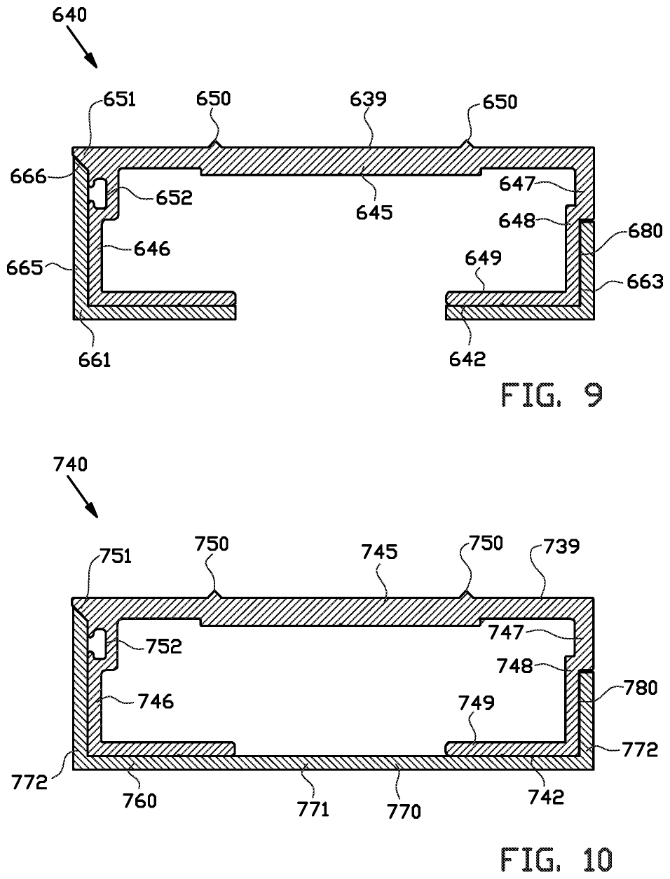

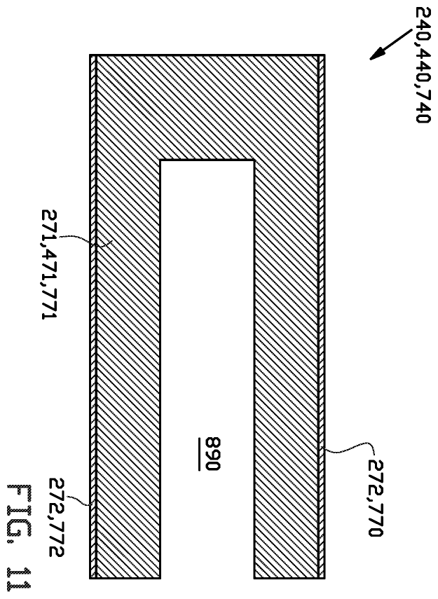

A cross-sectional view of the slat 240 of FIG. according to an alternative embodiment is shown in FIG. 10. In order to refrain from reintroducing components of the slat, similar components are referred to by the same reference number increased with 500 with respect to the description of the slat 240 shown in FIG. 5.

This embodiment of the slat 740 differs from the slat 240 of FIG. 5 in that the right side wall 747, in particular the first wall part 748 thereof, is provided with a recess 780 provided at the outer surface thereof, which recess 780 extends upwards from the bottom edge of the right side wall 747 to substantially halfway the total height of the first wall part 748. The right leg 772 of the U-shaped wear body 770 is arranged within the recess 780 of the right side wall 747, such that the outer surface of the right leg 772 within the recess 780 is substantially flush with the outer surface of the first wall part 748.

Furthermore, the top wall 745 is provided with a projecting nose or edge 751 at the side of the left side wall 746. The left leg 772 of the U-shaped wear body 770 has a skewed upper end 766, such that the elongated strip-like wear body 765 may be placed against the projecting nose or edge 751.

FIG. 11 shows a bottom view of one of the slats 240, 440, 740 as shown in FIGS. 5, 7 and 10. In particular, this figure shows the bottom portion 271, 771 of the U-shaped wear body 270, 770, or the bottom of the hollow beam-shaped wear body 471. As is clear from the figure, the bottom portion 271, 771 or the bottom comprises an opening 890 therein, such that the bottom portion 271, 771 or the bottom is at least partially open. Alternatively the bottom portion 271, 771 or the bottom is completely closed.

It is to be understood that the above description is included to illustrate the operation of the preferred embodiments and is not meant to limit the scope of the invention. From the above discussion, many variations will be apparent to one skilled in the art that would yet be encompassed by the scope of the present invention.

1-21. (canceled)

22. A slat for a reciprocating slat conveyor, the slat comprising:
an elongated slat body having an upper surface configured for supporting a load placed on the slat, a bottom surface, opposite to the upper surface, a first side surface and a second side surface, opposite to the first side surface,
wherein at least at one of the bottom surface, first side surface and second side surface of the elongated slat body is at least partially provided with a wear member.

23. The slat according to claim 22, wherein at least a part of each of the first side surface and the second side surface is provided with a wear member.

24. The slat according to claim 22, wherein at least a part of the upper surface is provided with a wear member.

25. The slat according to claim 22, wherein the elongated slat body comprises a top wall, and a left and right side wall arranged at a longitudinal side of the top wall and extending downwards therefrom.

26. The slat according to claim 25, wherein each of the left and right side walls comprises a first wall part connected to the top wall and extending substantially perpendicular thereto, and a second wall part arranged at the end of the first wall part facing away from the top wall and extending towards the second wall part of the other one of the left and right side walls.

27. The slat according to claim 26, wherein the wear member is arranged at the first wall part of one of the left and right side walls, and a further wear member is arranged at the first wall part of the other of the left and right side walls.

28. The slat according to claim 27, wherein the first wall part of the left and right side walls has a height, and the wear member and the further wear member extend over substantially the complete height of the respective first wall part.

29. The slat according to claim 27, wherein the first wall part of the left and right side walls has a height, and the wear member extends over substantially the complete height of the respective first wall part and the further wear member extends over a part of the height of the respective first wall part.

30. The slat according to claim 26, wherein the wear member comprises a U-shaped wear body having a bottom portion and two legs standing upright from the bottom portion, wherein the bottom portion is arranged at the second wall parts of the left and right side walls and the two legs are arranged at at least a part of the first wall parts of the left and right side walls.

31. The slat according to claim 26, wherein the wear member comprises an inverted U-shaped wear body having a bottom portion and two legs standing upright from the bottom portion, wherein the bottom portion is arranged at the top wall and the two legs are arranged at at least a part of the first wall parts of the left and right side walls.

32. The slat according to claim 22, wherein the wear member is a wear strip or wear profile.

33. The slat according to claim 22, wherein the wear member is a L-shaped wear strip or L-shaped wear profile.

34. The slat according to claim 22, wherein the wear member is substantially beam-shaped, such that the slat is located within the wear member.

35. The slat according to claim 22, wherein the wear member is arranged removably at at least one of the upper surface, bottom surface, first side surface and second side surface.

36. The slat according to claim 22, wherein the wear member is manufactured from a material selected from the group comprising steel, wear aluminum, aluminum, plastics or the like.

37. The slat according to claim 22, wherein the wear member is arranged at the elongated slat body by welding, gluing, riveting, screwing, clamping or the like.

38. The slat according to claim 22, provided with an end cap mounted at one or both of the outer ends of the slat.

39. The slat according to claim 38, wherein the end cap is connected to the wear member or to the elongated slat body solely.

40. The reciprocating slat conveyor comprising a support structure or subdeck, multiple parallel elongate slats according to claim 22, that are supported by the support structure and that are slidable in the longitudinal direction with respect to the support structure, slide bearings between the support structure and the slats, and a drive mechanism for reciprocating sliding movement of the slats with respect to the support structure.

41. A trailer or truck comprising a reciprocating slat conveyor according to claim 40.
